(19) United States
(12) Patent Application Publication
(10) Pub. No.: US 2003/0120441 A1
(43) Pub. Date: Jun. 26, 2003

(54) Component fault detection

(75) Inventor: John D. Sotack, Rochester, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation.

(21) Appl. No.: 10/024,242

(22) Filed: Dec. 21, 2001

(51) Int. Cl. G06F 19/00

(52) U.S. Cl. 702/58

(57) ABSTRACT

Current supplied to a group of components is selectively sensed so that the current supplied when a particular component is the only active component can be compared to a reference current indicative of proper component operation. If there is a discrepancy, an alert can be generated. Can be applied on a larger scale to allow isolation of a subsystem, then a group within the subsystem, then a component with the group, etc.

### BACKGROUND AND SUMMARY

Electrical components are designed to operate at particular levels of voltage, current draw, and other monitorable characteristics. For example, servo systems are designed to run at a set velocity, which is monitored via an encoder mounted on the servo. If the servo operates above or below the set point, the servo controls can detect the aberrant behavior of the servo by, for example, sensing a corresponding deviation in encoder frequency and attempt to correct for the encoder frequency error. If the error is easily corrected by the system, the correction takes place and the servo continues to function. However, if the error in encoder frequency (velocity) begins to exceed certain limits, the control system will determine that it can no longer operate within specification. When this occurs, the controller typically disables the servo motor drive and issues an alert, such as, for example, a numerical code, to the main control system. This alert tells the main controller that the servo is no longer operating and that a fault has been declared.

The above sequence is a typical shutdown technique and reveals to the main control system that a servo hardware fault has occurred. No other information is passed on for evaluation to the tech rep or the customer. The problem that caused the error could well have been the motor hardware or could have been the load that is driven by the servo motor. If the problem is a marginal situation in either the load or the motor, determining the root cause could be difficult since faults might be intermittent. Also, there is no information stored in the system that could give a historical account of encoder frequency excursions that did not cause a shutdown. A history of encoder frequency values that shows poor behavior would be useful to service personnel, and there is thus a need for such a history. Tech reps or design engineers could use such a history to determine that, over a specified operating period, the frequency of the servo motor's deviations and the amplitude by which the motor had deviated from its set point.

An onboard microprocessor can selectively monitor a component, such as a motor or a solenoid, by selectively sensing current used by the component. While supplying sensors for each component of a system is not practical with current technology, embodiments sense the current supplied to a group of components when only one of the components is operating. The sensed current can be compared to a reference current indicative of proper component operation, and the result of the comparison can be recorded. If there is a discrepancy, then the component is likely defective and should be serviced. Recording the result can include storing the result in a computer memory, displaying an alert when there is a discrepancy between the reference current and the current supplied to the group of components, and/or recording the circuit to which current was supplied during sensing. Additionally, embodiments can allow access to the recorded result via a computer network, an on-board display, and/or a computer connected to a direct-connect port, such as a serial port. Using recursion, embodiments can be used to detect groups of components or subsystems that are having trouble, groups of components or subsystems within those groups or subsystems, etc., until a particular aberrant component is identified.

### BRIEF DESCRIPTION OF THE DRAWINGS

FIG. 1 shows a schematic of a machine in which embodiments can be employed.

FIG. 2 shows a schematic of systems of a machine in which embodiments might be employed.

FIG. 3 shows a schematic of a portion of a machine to which embodiments can be applied and the components such a machine can include.

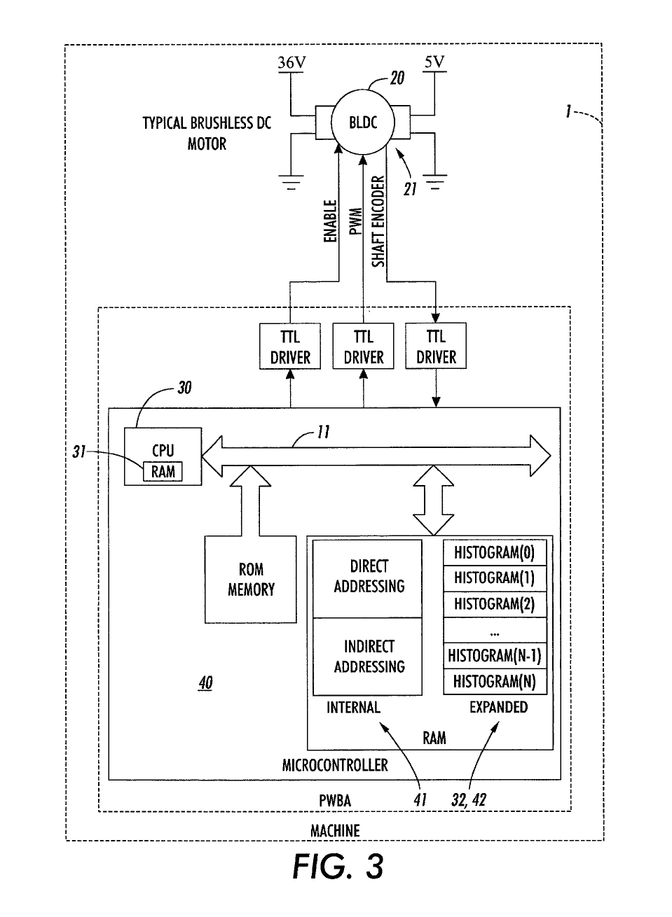

FIG. 4 shows a schematic chart illustrating a method that can be executed in embodiments of the invention.

### DETAILED DESCRIPTION

While this specification describes a technique that can identify an aberrant component, this is simply exemplary and one of ordinary skill in the art should realize that the technique can be applied to aberrant systems and groups of components without departing from the scope of the invention and recursively with whatever resolution might be appropriate for a particular application.

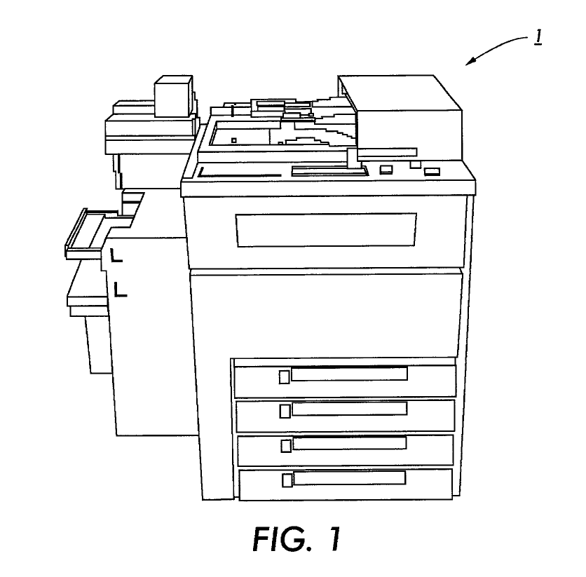

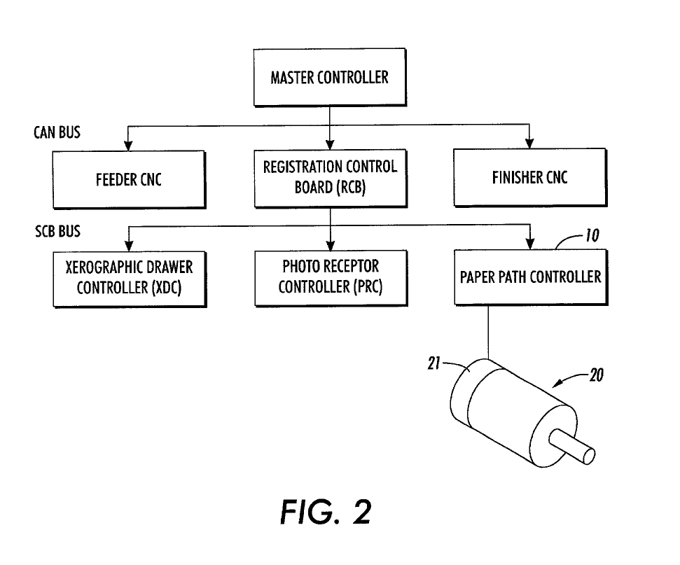

Embodiments can be employed in a printing machine 1, such as that shown in FIG. 1. Such printing machines typically include at least one main controller 10, as the controllers seen schematically, for example, in FIG. 2, that can, among other things, control a servo motor 20, as does the paper path controller 10, that can include a servo encoder 21. Such a main controller 10 typically includes at least one microprocessor 30, which will often include on-board random access memory (RAM) 31 or the like and/or can have access to expanded RAM 32 or the like. The microprocessor 30 can also be part of a microcontroller 40 that itself can include onboard RAM 41 or the like and/or can have access to expanded RAM 42 or the like.

The onboard microprocessor 30, in embodiments, selectively monitors a group of components 20 that includes a component 21, such as a motor, by sensing a characteristic of the component, such as current drawn by the group 20. For example, to determine whether the component 21 were operating properly, the microprocessor 30 would sense current drawn by the group 20 when the component 21 was the only component operating. The onboard microprocessor 30 would compare the current drawn by the group 20 to a reference current value indicative of proper operation and store the results in a memory, such as a RAM 31, 32, of the microprocessor. The data can remain in the memory for later retrieval or can be uploaded to another location, such as a main controller 10 or to non-volatile memory, such as a hard drive. The uploads can be continuous or at intervals. The system can be configured so that only those values outside of normal limits would be stored for analysis.

Advantageously, embodiments can recursively employ this technique to monitor systems, subsystems, and subgroupings within subsystems on down to individual components, depending on the particular configuration of the machine 1 in which embodiments are employed and the particular resolution desired. As illustrated in

In embodiments in which more components are monitored, more RAM 31, 32, 41, 42 can be necessary and more processing time can be required. Thus, in such embodiments, the microprocessor 30 should be relatively fast and have RAM 31, 32 available internally or externally for the storage. For example, the microprocessor 30 could be an Intel P89C51RB2 with 256 bytes RAM and 256 bytes Flash on board, or the microprocessor 30 could be of another type with external RAM chips for the micro's use. Additionally, a microcontroller 40 with 1 kB of internal RAM could be used in the six cycle clock mode. Running in this mode essentially doubles the internal speed of the controller's 40 processing capabilities. Therefore, for example, a P89C51RD2 (with 1 KB internal RAM 41) by Intel could be used that would run at twice the normal speed. This would be more than enough to handle the required processing. Additionally, for example, standard, off-the-shelf external RAM integrated circuits 42 could be used to augment data storage. Any amount of external RAM 42 would then be placed on the board that would meet the required storage needs.

More real time would be needed to hand data from the target micro 30, 40 to the main controller 10. Also, traffic on the serial bus system 11 would increase in order to get the data across. The main control unit 10 would be responsible for decisions about the health of the system according to its analysis, which would require additional real time from the main unit 10.

The system main controller 10 can thus obtain a history of aberrant component events, such as aberrant motor encoder events, or could even obtain histories of multiple components, subsystems, and systems in the machine. The main controller 10 could then make decisions about machine operation that could be communicated to, for example, service personnel. When a predetermined threshold of events is reached, for example, the machine diagnostics could alert service that a failure is eminent. Further, service could access this data, locally or remotely, and determine if further repairs are needed. The information obtained from the system could be used to determine the cause of an intermittent problem.

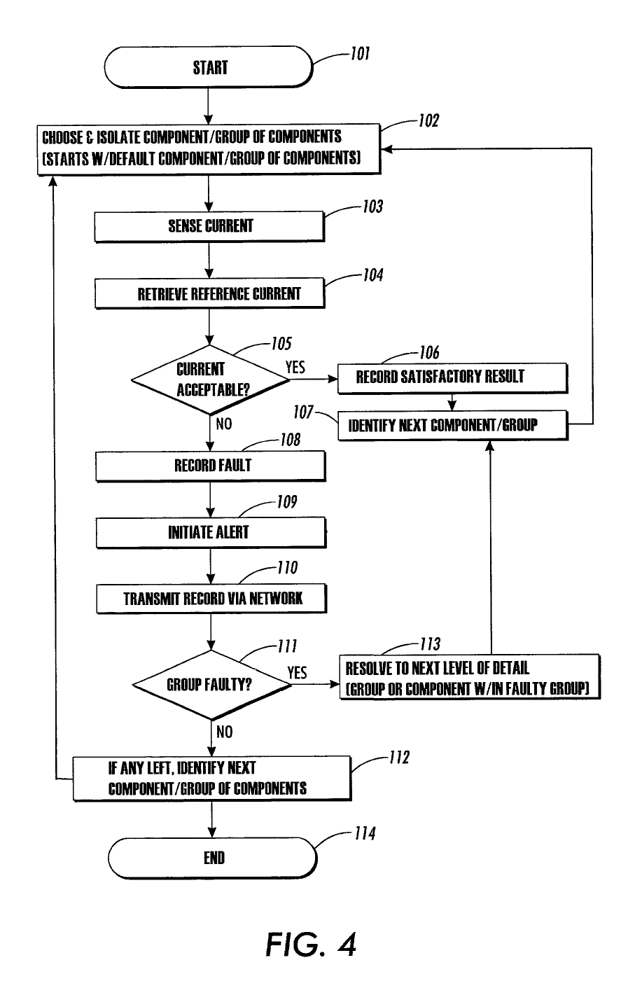

A schematic illustration of a method executed in embodiments is shown in FIG. 4. The method can start, block 101, and select and isolate a first component or group of components, block 102. The selection and isolation can start with a default component or group of components to test, such as might be stored in a RAM 31 or ROM of the controller 10. Once the component or from to be tested has been selected, current is sensed, block 103. A reference current is retrieved for the component or group being tested, block 104, which reference current can, for example, be stored in RAM 31 or ROM of the controller, or on a hard disk in communication with the controller. The sensed current and reference current are compared, block 105, and if the sensed current is acceptable, a satisfactory result can be recorded, block 106, the next component or group is identified, block 107, and the method can return to block 102. If the sensed current is not acceptable, then a fault is recorded, block 108, an alert can be initiated, block 109, and/or a record can be transmitted via a connected network, block 110. If the fault was in a group, block 111, then the next level of detail within that group can be resolved for testing, block 113, the next component or group is identified, block 107, and testing can continue from block 102. If the fault was in a component, then, if any remain, the next component or group of components can be identified, block 112, and testing can continue from block 102. If there are no more components or groups to be tested, then testing can stop, block 114.

While embodiments have been described in the context of monitoring a motor encoder 21, those of ordinary skill in the art should recognize that other components could be monitored using the method and apparatus described above. For example, this technique can be used on other applications such as sensor readings, power supply voltage readings, timing functions, and the recording of pulse width modulation (PWM) values. Data can be kept on almost any application that could help machine diagnostics. It could be accomplished at the firmware level as with the motor encoder and the data could be analyzed there or at the main control. Sensor pullin/pullout times and electromechanical clutch pullin/pullout times can be treated in the same manner. Power supply voltages can be monitored and any deviations be placed into their own histograms. Any device using PWM control would fit the algorithms of this technique. The histograms of all of these items, including paper path timing, could be stored on the microcontroller or microprocessor and read by the main control board or a remote computer at some convenient time. Further, the method can be applied recursively to test an entire machine's systems and subsystems.

Other modifications of the present invention may occur to those skilled in the art subsequent to a review of the present application, and these modifications, including equivalents thereof, are intended to be included within the scope of the present invention.

What is claimed is:

1. An aberrant component detection method comprising:
storing, in a computer memory, a reference current indicative of proper functioning of a particular component;
sensing current supplied to a group of components including the particular component;
comparing the current supplied to the group of components to the reference current; and
recording a result of comparing the current to the reference current.

2. The method of claim 1 wherein recording a result comprises storing the result in a computer memory.

3. The method of claim 2 wherein the computer memory is non-volatile.

4. The method of claim 1 wherein recording a result comprises displaying an alert when there is a discrepancy between the reference current and the current supplied to the group of components.

5. The method of claim 1 wherein recording a result includes recording the circuit to which current was supplied during sensing.

6. The method of claim 1 wherein sensing current includes sensing while only the particular component draws current.

7. The method of claim 1 further comprising allowing access to recorded results.

8. The method of claim 7 wherein allowing access comprises providing a connection to and allowing access via a computer network.

9. The method of claim 8 wherein the computer network is the Internet.

10. The method of claim 7 wherein allowing access comprises providing a user interface via an on-board display.

11. The method of claim 7 wherein allowing access comprises providing a port, allowing connection of a computer to the port, and providing access with the connected computer to the stored results.

12. An aberrant component detection method comprising recording a result of comparing a sensed current to a reference current, the sensed current being supplied to a group of components including the particular component, the reference current being indicative of proper functioning of a particular component and being stored in a computer memory.

13. The method of claim 12 wherein recording a result comprises at least one of storing the result in a computer memory, displaying an alert when there is a discrepancy between the reference current and the current supplied to the group of components, and recording the circuit to which current was supplied during sensing.

14. The method of claim 13 wherein the result, if stored, is stored in a non-volatile computer memory.

15. The method of claim 12 wherein the computer memory is non-volatile.

16. The method of claim 12 wherein sensing current includes sensing while only the particular component draws current.

17. The method of claim 12 further comprising allowing access to recorded results.

18. The method of claim 17 wherein allowing access comprises at least one of providing a connection to via a computer network, providing a user interface via an on-board display, and providing access via a computer connected to a direct-connect port.

19. An aberrant component detection method comprising:
storing, in a computer memory, a reference current indicative of proper functioning of a particular component;
sensing current supplied to a group of components including the particular component while only the particular component draws current;
comparing the current supplied to the group of components to the reference current; and
recording a result of comparing the current to the reference current, wherein recording a result comprises at least one of storing the result in a computer memory, displaying an alert when there is a discrepancy between the reference current and the current supplied to the group of components, and recording the circuit to which current was supplied during sensing.

20. The method of claim 19 further comprising allowing access to recorded results, wherein allowing access comprises at least one of providing a connection to and allowing access via a computer network, providing a user interface via an on-board display, and providing access via a computer connected to a direct-connect port.

21. The method of claim 19 wherein the particular component is itself a group of components and the method is applied recursively to identify an aberrant particular component within the particular component.
